(19) United States
(12) Patent Application Publication
(10) Pub. No.: US 2020/0352202 A1
(43) Pub. Date: Nov. 12, 2020

(54) PLANT-BASED NON-DAIRY FERMENTED BASE COMPOSITION AND METHODS OF MAKING AND USING THE SAME

(71) Applicant: THE QUAKER OATS COMPANY, Chicago, IL (US)

(72) Inventors: Michelle JOHNSON, West Dundee, IL (US); Sundar BALA, Arlington Heights, IL (US); Kris SUBRAMANIAN, Vernon Hills, IL (US); Geoffrey PFEIFER, Ojai, CA (US)

(21) Appl. No.: 16/406,840

(22) Filed: May 8, 2019

(51) Int. Cl. A23L 25/00; A23L 33/185; A23L 29/206

(52) U.S. Cl. CPC A23L 25/40; A23V 2002/00; A23L 29/206; A23L 33/185

(57) ABSTRACT

The present disclosure relates to a plant-based non-dairy fermented base composition and methods of making and/or using the plant-based non-dairy fermented base composition to produce nutritional products, such as food and beverage products, particularly food, snack, and/or beverage products.

### FIELD OF THE PRESENT DISCLOSURE

The present disclosure relates to a plant-based non-dairy fermented base composition and methods of making and/or using the plant-based non-dairy fermented base composition to produce nutritional products, such as food, snack, and/or beverage products, particularly food, snack, and/or beverage products.

### BACKGROUND

Dairy products are known to most consumers to be one of the five major food groups, along with fruits, vegetables, grains, and protein foods that are recommended by the U.S. Food and Drug Administration (FDA) to be included in the balanced nutritional diet of humans. In particular, dairy products are key ingredients of the human diet because they are an important source of nutrients, including, but not limited to calcium, minerals (e.g., phosphorus, potassium, zinc, choline, magnesium, and selenium), and vitamins (e.g., A, D, B2 or riboflavin, and B12). Consequently, the current commercial market is saturated with dairy products made for human consumption, including but not limited to numerous forms, varieties, and brands of milk, cheese, yogurt, butter, sour cream, ice cream, etc.

Animal-based dairy products typically originate from cows, buffalos, sheep, goats, and/or camels, and less commonly from animals such as yaks, horses, reindeers, and donkeys. However, it is also known that the saturated fat comprised in milk and other animal-based dairy products may have a negative impact on human health if consumed beyond the daily amounts recommended by the U.S. FDA. For example, the saturated fat comprised in animal-based dairy products has been associated with increased risk of human health disorders and conditions, including but not limited to obesity, diabetes, cardiovascular disease, osteoporosis, and cancers (e.g., breast, ovarian, and prostate cancers). Therefore, in an effort to focus more on health and nutrition, as well as allergy and/or diet concerns, consumers have demanded non-dairy products to avoid potential health risks associated with consumption and/or overconsumption of dairy products.

Plant-based non-dairy products have been an optional alternative to animal-based dairy products for many health conscientious consumers. For example, plant-based non-dairy products, include but are not limited to products comprising soy, almond, rice, coconut, and hemp products, which are often marketed as “milks” or even as “dairy products” because they typically provide a source of calcium. However, these plant-based non-dairy products do not generally contain similar nutritional content without fortification, including the vitamins and minerals, provided by animal-based dairy products. Consequently, many plant-based non-dairy products, such as soy-based food, snack, and/or beverage products, are often fortified with calcium and vitamins (e.g., vitamins A and D) to provide similar nutritional, texture, and/or sensory profiles as standard animal-based dairy products in order to be appealing to consumers.

However, current non-dairy food, snack, and/or beverage alternatives often have a gap and/or are lacking in texture, taste, and/or sensory characteristics that are appealing to consumers. There are also gaps and/or deficiencies in the nutritional delivery and/or efficacy of non-dairy products to humans due to the lack of protein and fat in such plant-based products. For example, plant-based non-dairy food, snack, and/or beverage products in the art often include, but are not limited to products comprising a nut-based composition.

More specifically, nut-based non-dairy food, snack, and/or beverage products in the art may comprise a base composition including, but not limited to almonds, coconuts, and/or cashews. These nut-based non-dairy base compositions often also include the use of additives, such as thickening and/or stabilizing agents. Thickening agents may be added to current plant- and/or nut-based non-dairy compositions in an attempt to improve the nutritional, sensory, flavor, and/or clean-label characteristics of the final food, snack, and/or beverage products. For example, consumers of many current plant- and/or nut-based non-dairy food, snack, and/or beverage products desire improved flavor and/or taste delivery without the addition of substantial sugar content.

While plant-based base compositions are currently used in the art to produce non-dairy food products, the fermentation process of making or producing such plant-based non-dairy fermented food, snack, and/or beverage products requires potentially expensive ingredients, and often, is not tightly controlled, or able to achieve desirable textures and sensory characteristics as with dairy fermented products. Therefore, a need exists for new and improved ingredients and product components used in the methods and processes for producing a plant-based non-dairy base composition that may subsequently be used to generate food, snack, and/or beverage products with improved nutritional, sensory, flavor, and/or texture characteristics that are advantageous to consumers and therefore, also for commercial retail.

### SUMMARY OF THE INVENTION

The present disclosure provides a plant-based non-dairy fermented base composition. The plant-based non-dairy fermented base composition of the present disclosure may comprise: 1) a substrate, 2) a sugar source, 3) a medium, 4) a thickener, and 5) a starter culture. The starter culture of the base composition comprises live bacteria. In one embodiment, the starter culture of the base composition consists essentially of live bacteria.

The medium of the base composition may be a liquid medium. The liquid medium may be water. The thickener of the base composition may be selected from the group consisting of agar, pectin, arracacha flour, plantain flour, banana flour, banana yogurt, banana puree, locust bean gum “carob,” cassava powder, ground chia seeds, tapioca starch, ground flaxseed, chicory root extract, xantham gum, guar gum, arrow root starch, corn starch, and/or combinations thereof.

The substrate of the base composition may be a plant-based substrate. The plant-based substrate of the base composition may comprise nuts. Nuts of the substrate may be selected from the group consisting of almonds, cashews, coconuts, peanuts, hazelnuts, pecans, pistachios, walnuts, macadamia nuts, brazil nuts, pine nuts, chestnuts, and combinations thereof.

The substrate, the sugar source, the thickener, and the medium may be comprised in a slurry. The slurry may further comprise a protein source. The protein source may be any plant protein. In some embodiments, the plant protein source is not soy protein. An exemplary protein source is pea protein. The slurry of the present disclosure may further comprise one or more enhancers. The one or more enhancers are selected from the group consisting of a flavoring or flavoring agent, a surfactant, an adjuvant, an excipient, a dispersant, an emulsifier, a coloring, an additive, a probiotic, a mineral, a salt, a yeast extract, and combinations thereof.

The present disclosure is also related to a nutritional product comprising the plant-based non-dairy fermented base composition. The nutritional product may be a yogurt alternative. The nutritional product may be a food, a snack, an elixir, a shot, a shooter, a spoonable product, a spreadable product, a drinkable product, a squeezable product, a smoothie, a shake, a soup, or a beverage. The spoonable product may be a yogurt alternative.

The present disclosure is also related to a method of making or producing the described plant-based non-dairy fermented base composition. The method of making or producing the base composition may comprise: 1) mixing a starter culture and a slurry to form a mixture, 2) fermenting the mixture to produce an amount of lactic acid, 3) reducing the pH of the mixture so that the pH ranges from about 3.8 to about 4.6, 4) cooling the mixture to stop production of the lactic acid, and 5) producing the plant-based non-dairy fermented base composition.

Finally, the present disclosure is directed to a method of fermenting the described plant-based non-dairy fermented base composition. The method of fermenting the base composition may comprise: 1) mixing a starter culture and a slurry to form a mixture, 2) producing an amount of lactic acid from the mixture, 3) reducing the pH of the mixture so that the pH ranges from about 3.8 to about 4.6, and 4) cooling the mixture to stop production of the lactic acid.

### BRIEF DESCRIPTION OF THE DRAWINGS

The detailed description particularly refers to the accompanying figures as described below.

FIG. 1 is a schematic that shows one general embodiment of the present methods of making, producing, and/or fermenting the plant-based non-dairy base composition.

FIG. 2 is a schematic that shows one specific embodiment of the present methods of making, producing, and/or fermenting the plant-based non-dairy base composition.

FIG. 3 is a screenshot schematic of a Protein Quality Calculator Tool report that shows the protein concentration for a plant-based non-dairy base composition comprising about 17% substrate (i.e., almond butter) without any additional protein source.

FIG. 4 is a screenshot schematic of a Protein Quality Calculator Tool report that shows the protein concentration for a plant-based non-dairy base composition comprising about 17% substrate (i.e., almond butter) and about 8% of an additional protein source (i.e., pea protein).

FIG. 5 is a graph that shows the pH of the acidification curves for seven replicate samples of an embodiment of the plant-based non-dairy base compositions fermented at about 100° F. (i.e., about 37.8° C.) for about 20-25 hours.

### DETAILED DESCRIPTION

### Definitions

The phrase “and/or” refers to the inclusion of several embodiments described or implied in the present disclosure comprising one of the described components, compositions, agents, or steps of the embodiment; all of the components, compositions, agents, or steps of the embodiment; or a combination of one or more of the components, compositions, agents, or steps of the embodiment of the invention of the present disclosure.

“Anaerobic” conditions of the present disclosure refer to an environment and/or an atmosphere where about 21% or less of free oxygen (i.e., O₂) is present, although other forms of oxygen may be present in the same environment and/or atmosphere. Anaerobic conditions are present when no free oxygen (i.e., about 0% O₂) is present.

Degrees of “Brix” refer to the sugar content of a solution, such as an aqueous solution. One degree Brix (1° Bx) equals 1 gram (g) of sugar (e.g., sucrose, glucose, dextrose, and/or fructose) in 100 g of solution. Thus, the term “Brix” refers to the strength of the sugar content in a solution as a percentage of mass. If the solution contains dissolved solids other than pure sugar (e.g., sucrose, glucose, dextrose, and/or fructose), then the unit “Brix” refers to the approximate amount of dissolved solid content in the solution.

The terms “composition” or “compositions” refer to one or more compounds, components, or agents with or without the addition of another compound, component, or agent, making the composition especially suitable for use as a food or a beverage product.

The terms “component” or “components” refer to a constituent part of a composition. For example, components of a composition of the present disclosure can include one or more chemical compounds, cells and/or cell cultures (e.g., live bacteria), ingredients (e.g., a food or beverage ingredient), and/or any other agent present in the composition. Additional components of the composition of the present disclosure may include, but are not limited to, flavorings, surfactants, adjuvants, excipients, dispersants, emulsifiers, additives, etc.

A “combination” refers to a joining of one or more compounds, components, agents, and/or compositions to another compound, component, agent, and/or composition or to a plurality of compounds, components, agents, and/or compositions. The “combination” may comprise, consist essentially of, or consist of cells and/or cell cultures (e.g., live bacteria), compounds, compositions, components, constituents, elements, moieties, molecules, or mixtures. A combination includes, but is not limited to, a mixture.

The term “comprising” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

The term “drinkable” refers a composition that is able to be ingested by a human subject through the mouth, throat, and/or esophagus typically by drinking. An illustrative embodiment of a “drinkable” composition of the present disclosure is a beverage product. Illustrative “drinkable” beverages include, but are not limited to water, juices, sodas, smoothies, shakes, teas, lemonades, coffees, frappes, lattes, cappuccinos, etc.

The term “elixir” refers to a composition that may provide some medicinal and/or curative effect to any symptom or sign of a disease, a disorder, or an ailment of a subject. An “elixir” of the present disclosure is generally in the form of a food, snack, and/or beverage product. An illustrative “elixir” is a beverage product comprising the non-dairy fermented water kefir base composition of the present disclosure.

The terms or phrases “effect,” “effective,” and “effective amount” refer to the amount of a composition, component, and/or compound sufficient to provide beneficial or desired results. An effective amount of any composition and/or component of the present disclosure may be administered via ingestion of a food, snack, and/or beverage product comprising the non-dairy fermented water kefir base composition of the present disclosure.

The phrases “live yeast” and/or “live bacteria” refer to one or more different cultures of yeast and/or bacterial strains that are alive (i.e., living) and able to reproduce to quantities significant enough to form, establish, and maintain a larger microbial culture. “Live yeast” and/or “live bacteria” cell cultures may be purchased at commercial manufacturers, including, but not limited to American Type Culture Collection (ATCC), Chr. Hansen, DuPont, and/or Lallemond, etc. In one embodiment of the present disclosure, cultures of “live yeast” and/or cultures of a symbiotic colony of bacteria and yeast (SCOBY) are not used.

The phrase “non-dairy” refers to a composition that contains little or no amount or concentration of a dairy component, which may include, but is not limited to, milk (including buttermilk, powdered milk, evaporated milk, and any percentage of whole milk, such as 1% or 2% milk), cheese (including cottage cheese and cheese sauces), butter and butter fat, cream (including sour cream), yogurt, ice cream, and/or pudding. In some embodiments, a “non-dairy” product or composition of the present disclosure may comprise about 5% or less of any dairy component, such as 2% or less. Importantly, some embodiments of a “non-dairy” composition of the present disclosure may also comprise about 5% or less of any dairy protein and/or dairy allergens.

The “non-dairy” composition may be dairy protein and/or dairy allergen-free, such that no (i.e., 0%) or little (i.e., 2% or less) of any dairy protein and/or dairy allergens are present in the “non-dairy” composition. Illustrative dairy proteins and dairy allergens that should not be present or should be maintained in limited quantities and/or concentrations (i.e., 2% or less) in the “non-dairy” composition of the present disclosure include, but are not limited to casein or caseinates, curd, ghee, hydrolysates, lactalalbumin and lactalbumin phosphate, lactose, lactoglobulin, lactoferrin, and lactulose, rennet, whey, and whey products.

A “starter culture” of the “live yeast” and/or “live bacteria” of the present disclosure may comprise a range of about 1×10⁵ to 1×10⁸ CFU/g (colony forming units per gram) of active units of “live yeast” and/or “live bacteria.” Preferably the starter culture comprises of about 5×10⁵ to 5×10⁶ CFU/g of active units of culture. In particular, the usage of the starter culture comprising “live yeast” and/or “live bacteria” may be at a rate ranging from about 100 g to about 25,000 g of active units of “live yeast” and/or “live bacteria” per 1000 gallons of medium (e.g., water). This usage rate equates to about 0.1 g to about 25 g of active units/gallon of medium. In addition, the usage rate of the starter culture may range from about 0.25 g to about 25 g/gallon, from about 0.4 g to about 25g/gallon, from about 0.45 g to about 20 g/gallon, from about 0.1g to about 0.5 g/gallon, from about 0.25 g to about 0.5 g/gallon, and from about 4 g to about 21.5 g/gallon.

Typically, a starter culture comprises active units of one or more different strains of “live yeast” and/or “live bacteria.” An embodiment of the starter culture of the present disclosure does not comprise “live yeast” at all. In another embodiment of the starter culture of the present disclosure comprises, consists essentially of, or consists of “live bacteria” only. Further, an embodiment may comprise, consist essentially of, or consist of only “live lactic acid bacteria.” For example, a starter culture may comprise 1 to 100 different strains of “live bacteria.” Generally, the starter culture comprises, consists essentially of, or consists of about 1 to about 10 strains, from about 1 to about 5 strains, from about 1 to about 3 strains, and at, at least, or about 2 strains of different “live bacteria.” An illustrative embodiment of the “live bacteria” of the present disclosure comprises, consists essentially of, or consists of Lactobacillus bulgaricus and Streptococcus thermophilus.

Recently, it was identified that a culture or “starter culture” of “live bacteria” of the present disclosure may be grown or commercially purchased in the presence of an allergen-free base, such as a dairy allergen-free base composition. An illustrative embodiment of the starter culture and/or “live bacteria” of the present disclosure may comprise, consist essentially of, or consist of no allergens, such that the starter culture and base composition are allergen-free. In another embodiment, the starter culture and/or “live bacteria” is dairy-free, and thus comprises no dairy allergens. Accordingly, the starter culture may be GRAS-approved, and specifically, GRAS-approved for a non-dairy format.

The term “base” or the phrases “base ingredient” or “base composition” refer to a composition produced when a “starter culture” has been inoculated into a medium, to produce a slurry. Alternatively, the base composition of the present disclosure is produced when the “starter culture” is inoculated into the slurry comprising the medium. The “starter culture” is processed and/or grown in order to result in a larger culture. The base composition of the present disclosure comprises, consists essentially of, or consists of the starter culture before or after the fermentation process (e.g., pre-fermentation or post-fermentation) occurs in the slurry, as described herein.

To produce the “base composition, the “starter culture” may be inoculated onto a solid medium or into a liquid medium. An illustrative embodiment is a liquid medium. An illustrative liquid medium of the present disclosure is sugar water, juice, or syrup (e.g., fruit and/or vegetable juice or syrup).

In one embodiment, the liquid medium may comprise, consist essentially of, or consist of a carbon. The carbon of the liquid medium may include, but is not limited to a disaccharide sugar or a monosaccharide sugar. An illustrative disaccharide sugar of the present disclosure includes, but is not limited to sucrose. An illustrative monosaccharide sugar of the present disclosure includes, but is not limited to glucose, fructose, or combinations thereof.

In the same or a different embodiment as that comprising a carbon, the liquid medium of the may also comprise, consist essentially of, or consist of a nitrogen source. Illustrative embodiments of nitrogen sources of the present disclosure include, but are not limited to a form of nutritive yeast and/or a yeast extract.

In addition to the carbon and nitrogen sources, the starter culture of the present disclosure may further comprise a mineral source. An illustrative mineral source of the present disclosure includes, but is not limited to a form of nutritive minerals, such as crude minerals or refined minerals.

Once inoculated into the medium to produce the slurry, the “starter culture” may be metabolized and/or processed, such as by the process of fermentation. Generally, “fermentation” refers to the general process by which microorganisms (e.g., yeast and/or bacteria) are grown on a growth medium. Fermentation typically occurs under “anaerobic conditions” in the environment and/or atmosphere, and often produces a specific chemical compound and/or product at the end of the process. Notably, fermentation of the “starter culture” of the present disclosure typically produces an exemplary “base composition” or “base ingredient” of the present disclosure.

In the present disclosure, the term “fermentation” generally refers to the metabolic process where carbohydrates, such as sugars, are metabolized by “live yeasts” and/or “live bacteria” and converted into acids, gases, and/or alcohols. In an illustrative embodiment of fermentation of the present disclosure, homofermentative “live bacteria” are able to convert sugar to acid, rather than alcohol, and may also be comprised in the “base composition” or “base ingredient” of the present disclosure. Illustrative acids produced by the homofermentative conversion of sugar by “live bacteria” include, but are not limited to lactic acid, acetic acid, gluconic acid, citric acid, succinic acid, combinations thereof, and others, including organic acids.

Fermentation acids of the present disclosure may also comprise, consist essentially of, or consist of organic acids. The organic acid of the present base composition may be selected from the group consisting of acetic acid, lactic acid, citric acid, succinic acid, gluconic acid, fumaric acid, phosphoric acid, malic acid, oxalic acid, ascorbic acid, and combinations thereof. An illustrative acid or organic acid of the present base composition may also comprise, consist essentially of, or consist of an acid that is not lactic acid.

“Optional” or “optionally” refers to a circumstance in which the subsequently described event or circumstance may or may not occur, and that the description includes instances where the event or circumstance occurs and instances in which it does not. “Optionally” is inclusive of embodiments in which the described condition(s) are present and embodiments in which the described condition(s) are not present.

The terms and/or phrases “plant(s),” “plant material(s),” “plant crops,” and “plant part(s)” include, but are not limited to, whole plants, portions of plants, pieces of plants, parts of plants, plant cells, and/or plant tissues. Illustrative “plants,” “plant material(s),” and/or “plant part(s)” of the present disclosure include, but are not limited to leaves, calli, stems, pods, roots, fruits, flowers, pollen, nuts, seeds, egg cells, zygotes, cell culture, tissue culture, and/or any other part, piece, portion, and/or product of a plant. In one embodiment, “plants,” “plant material(s),” and/or “plant part(s)” includes cotyledon and leaf. In another embodiment, “plants,” “plant material(s),” and/or “plant part(s)” include root tissues and other plant tissues located underground.

The term “pasteurization” or “pasteurizing” refers to a process where a composition (e.g., the slurry, base, food, snack, and/or beverage compositions of the present disclosure) are heat treated in order to eliminate and/or kill pathogenic microorganisms and other undesired organisms, including but not limited to bacteria, fungi, viruses, and/or yeast. Heat may be directly and/or indirectly applied to the composition via any heat source means sufficient to kill pathogens, including but not limited to a heater, a heat exchanger (e.g., a plate heat exchanger), hot water, steam, etc. Typically, pasteurizing a composition involves treating with heat such that the composition is sterilized and/or sanitized by logarithmically destroying and/or inactivating microbial organisms that contribute to spoilage and/or degradation. Therefore, pasteurizing a composition also comprises a sterilization process that often helps to increase the shelf life and/or storage life of the treated composition or product.

The term “plurality” refers to one or more components, agents, and/or compositions of the present disclosure and may range up to an unlimited and/or unquantifiable number of the same components, agents, and/or compositions. A “plurality” may also refer to two or more or even three or more components, agents, and/or compositions and may range up to an unlimited and/or unquantifiable number of the same components, agents, and/or compositions.

A “probiotic” of the present disclosure refers to a plurality of live microorganisms that provides health benefits to a consumer. More specifically, the probiotic may provide improvements to the gut flora of a consumer that results in improved gut health. Probiotics may be added to the slurry and/or base composition or the food, snack, and/or beverage products of the present disclosure as an additional component or an enhancer. For example the probiotic may be added to the starter culture initially or added to the starter culture after fermentation (i.e., post-dosed) to achieve a target concentration of live microorganisms (e.g., live bacteria) as measured in CFU/gram.

The terms “shot” and “shooter” are interchangeable and refer to a small serving (e.g., about 2 to about 5 ounces) of a concentrated composition. For example, typically in the food industry, a “shot” refers to a small serving of a concentrated beverage, such as an alcoholic beverage.

The term “smoothie” refers to a blended beverage and/or spoonable composition that comprises a thick, smooth texture. Typically, a “smoothie” comprises ingredients, including, but not limited to fruits, vegetables, nuts, milk, yogurt, water, ice, juice, sweeteners, whey, herbal or nutritional supplements, and/or ice cream.

A “shake” refers to an embodiment of a “smoothie.” However, generally a “shake” comprises more sugar content, including more content of ice cream and flavorings, and less healthy or nutritional ingredients than a “smoothie.” Therefore, “shakes” are often considered to have less nutritional value than a “smoothie.” For example, typical flavors of a “shake” include vanilla, chocolate, caramel, or peanut butter. In addition, “shakes” generally have a higher protein content than “smoothies.”

The term “spoonable” refers to a composition that is able to be scooped and/or consumed with a spoon utensil. An illustrative embodiment of a “spoonable” composition of the present disclosure is a food, snack, and/or beverage product that is capable of and/or typically is eaten with a spoon utensil. Illustrative embodiments of a “spoonable” composition include, but are not limited to yogurt, pudding, ice cream, soups, etc.

The term “spreadable” refers to a composition that is able to be spread, such as with a utensil, including but not limited to a knife or a spoon. An illustrative embodiment of a “spreadable” composition of the present disclosure is a food and/or snack product that is capable of and/or is typically spread onto another food and/or snack composition, including but not limited to bread, chips, and/or crackers. In some embodiments, a “spreadable” composition may comprise, consist essentially of, or consist of a higher amount and/or concentration (w/w %) of solids than a “spoonable” composition. Illustrative embodiments of a “spreadable” composition include, but are not limited to dips, spreads, cheeses, jellies, jams, pâté, hummus, icings, glazes, frostings, condiments (e.g., mustard, mayonnaise, salad dressing, tartar sauce, etc.), salsa, honey, etc.

The term “squeezable” refers to a composition that is easily able to be squeezed directly onto a surface, such as the surface of a food, snack, and or beverage composition or directly into the mouth of a subject, and appropriately eaten without any need or use for a utensil (e.g., a fork, a knife, or a spoon). An illustrative embodiment of a “squeezable” composition of the present disclosure is a food and/or snack product that is capable of and/or is typically manually squeezed directly onto a food or inanimate surface or into a subject's mouth and eaten without the use of a utensil. Illustrative embodiments of a “squeezable” composition include, but are not limited to spreads, cheeses, whipped cream, yogurt, icings, glazes, frostings, condiments (e.g., mustard, mayonnaise, ketchup, and salad dressing), etc.

The terms “sterilization,” “sanitization,” “sanitizing,” or “sterilizing” refer to the process of killing and/or eliminating microorganisms that are detrimental to the safe and long-term storage of the slurry, base, food, snack, and/or beverage compositions of the present disclosure. In the present disclosure, the terms “sterilization,” “sanitization,” “sanitizing,” and/or “sterilizing” often refer to treatment of a composition via irradiation, such as with ultraviolet (UV) light treatment, or via a pasteurization process where compositions may be heat treated to eliminate microbial pathogens, such as bacteria, fungi, viruses, and/or yeast.

A “subject” of the present disclosure refers to a human or an animal. An illustrative “subject” of the present disclosure is a human. The exemplary “subject” of the present disclosure is a human.

A “thickener” or “thickening agent” of the present disclosure refers to any composition and/or component that increases the viscosity, and therefore, thickens the consistency of the composition to which it was added. Typically, addition of a thickener increases the viscosity of the final composition and/or product without substantially changing other properties and/or characteristics of the final composition and/or product. Illustrative “thickeners” of the present disclosure comprise compositions, substances, and/or components of the plant-based non-dairy fermented base composition that are capable of thickening the texture and/or consistency of the food, snack, and/or beverage products in which it is comprised.

Thickeners of the present plant-based non-dairy fermented base composition also typically improve the overall stability and suspension of the plant-based non-dairy fermented base composition. In addition, thickeners comprised in the plant-based non-dairy fermented base composition typically provide improved stability and suspension to other ingredients comprised within the food, snack, and/or beverage product, and thus, to the overall food, snack, and/or beverage product itself.

### Compositions and Components of the Present Methods

The methods of the present disclosure are directed to making, producing, fermenting, and/or using a plant-based non-dairy fermented base composition to produce nutritional products, such as food, snack, and/or beverage products. Food, snack, and/or beverage products of the present disclosure may comprise, consist essentially of, or consist of the plant-based non-dairy fermented base composition of the present disclosure. The food, snack, and/or beverage products of the present disclosure may be used for private, commercial, and/or retail sale.

The methods of the present disclosure comprise, consist essentially of, or consist of a plant-based non-dairy fermented base composition (“the base composition”). The plant-based non-dairy fermented base composition of the present disclosure comprises, consists essentially of, or consists of one or more of the following components: 1) a substrate, 2) a medium, 3) a carbon source, 4) a starter culture, 5) a thickener, and/or 6) a protein source.

The amount and/or concentration of substrate (w/w %) comprised in the base composition corresponds to the amount and/or concentration of solids (w/w %) in the base composition. The plant-based non-dairy fermented base composition of the present disclosure may comprise, consist essentially of, or consist of about 1% to about 40% (w/w) of a substrate or solids (see Table 1 below). More specifically, the base composition of the present disclosure may comprise from about 2.5% to about 35%, from about 5% to about 30%, from about 7.5% to about 28%, from about 5% to about 25%, from about 8% to about 23%, from about 10% to about 22%, from about 11% to about 21%, from about 15% to about 20.5%, from about 12% to about 20%, from about 12% to about 25%, from about 16% to about 18%, about 15%, about 16%, about 17%, about 18%, about 19%, and about 20% of a substrate (see Tables 1-3 below). In an illustrative embodiment, the base composition comprises from about 15% to about 20%, such as about 17%, 17%, less than 17%, or 17% or less of the substrate.

The substrate may comprise, consist essentially of, or consist of plants and/or plant parts in order to form the plant-based non-dairy base composition of the present disclosure. A class of plants and/or plant parts that may be comprised in the substrate is generally as broad as the class of higher and lower plants including, but not limited to, dicotyledonous plants, monocotyledonous plants, agronomic crops, and horticultural crops. Agronomic crops include, but are not limited to horticultural crops and minimally-processed versions thereof. Horticultural crops of the present disclosure include, but are not limited to, vegetable crops, fruit crops, edible nuts, flowers and ornamental crops, nursery crops, aromatic crops, and medicinal crops.

More specifically, horticultural crops of the present disclosure include, but are not limited to fruits, vegetables, nuts, and/or ornamental plants. An exemplary horticultural crop of the substrate is one or more nuts. Illustrative nuts of the substrate include but are not limited to almonds, cashews, coconuts, peanuts, hazelnuts, pecans, pistachios, walnuts, macadamia nuts, brazil nuts, pine nuts, chestnuts, and combinations thereof. Thus, the substrate may comprise, consist essentially of, or consist of one or more nuts in order to form the nut-based non-dairy base composition of the present disclosure.

The plant- and/or nut-based substrate may be in any form that promotes fermentation. More specifically, the substrate may be in a form that includes, but is not limited to a milk, a butter, a paste, a powder (e.g., a flour), a liquid, a gel, a cube (e.g., a bullion), a tablet, etc. While any form of substrate may be used in the base composition of the present disclosure, an illustrative embodiment of the substrate is a butter or a paste. For example, an exemplary substrate of the plant-based non-dairy base composition of the present disclosure is almond butter, including, but not limited to roasted, unroasted, and raw roasted almond butter.

A medium of the plant-based non-dairy base composition provides the necessary nutrient-rich environment where the live bacteria of the starter culture is processed and/or grown in order to produce a larger culture comprising, consisting essentially of, or consisting of a base composition, such as the plant-based non-dairy fermented base composition of the present disclosure. To produce a base composition, the starter culture may be inoculated onto a medium, including, but not limited to a solid medium, a liquid medium, a gel medium, and other types of mediums known in the art for use in microbial cell culture. A solid medium of the present disclosure includes, but is limited to one or more lyophilized flakes (i.e., a plurality of flakes) or a powder.

An exemplary medium for the plant-based non-dairy fermented base composition of the present disclosure is a liquid medium. A liquid medium within which the starter culture is inoculated may comprise, consist essentially of, or consist of a solution and a sugar (i.e., a sugar source). In some embodiments, the liquid medium comprises a solution, but does not comprise a sugar.

An illustrative solution of the liquid medium of the present disclosure is an aqueous solution. An aqueous solution of the medium may comprise, consist essentially of, or consist of water, juice, and/or syrup (e.g., fruit and/or vegetable juice or syrup). An exemplary solution of the liquid medium of the present disclosure is water.

The plant-based non-dairy fermented base composition comprises, consists essentially of, or consists of a medium, particularly, a liquid medium (e.g., water), from about any source providing potable water for human ingestion. Typically, the liquid medium of the base composition comprises, consists essentially of, or consists of about 30% to about 99% of the base composition of the present disclosure (see Table 1 below). More specifically, the base composition may comprise, consist essentially of, or consist of about 60% to about 95%, from about 50% to about 97%, from about 45% to about 96%, from about 70% to about 85%, from about 40% to about 98%, from about 50% to about 85%, from about 65% to about 85%, from about 70% to about 85%, from about 73% to about 83%, from about 71% to about 86%, from about 72% to about 82%, from about 71% to about 81%, from about 70% to about 75%, from about 72% to about 74%, from about 77% to about 85%, from about 79% to about 83%, and 73%, about 73%, 81%, and about 81% of water (see Tables 1-3 below). Illustrative water of the base composition includes, but is not limited to tap water, purified water, spring water, and/or distilled water. An illustrative embodiment of purified water of the base composition is reverse osmosis (RO) purified water or RO water.

In addition to the substrate and the medium, the plant-based non-dairy fermented base composition of the present disclosure may also comprise, consist essentially of, or consist of a thickener. A thickener of the base composition may be any composition known or used in the art to increase the viscosity of an edible composition. In addition, a thickener of the base may be any thickening composition appropriately used in the preparation of food, snack, and/or beverage products that is safe for ingestion by subjects, such as humans. More specifically, the thickener may be in a form that includes, but is not limited to a milk, a butter, a paste, a powder, a liquid, a gel, a cube (e.g., a bullion), a tablet, a puree, a yogurt, etc. While any form of thickener may be used in the base composition of the present disclosure, an illustrative embodiment of the thickener is a powder, such as a flour.

The base composition of the present disclosure comprises, consists essentially of, or consists of about 0.1% to about 5% of the thickener (see Table 1 below). More specifically, the base composition may comprise from about 0.15% to about 4.5%, from about 0.2% to about 4%, from about 0.25% to about 3.5%, from about 0.3% to about 3%, from about 0.35% to about 2.5%, from about 0.4% to about 2.3%, from about 0.5% to about 3%, from about 0.5% to about 2%, from about 0.1% to about 1%, from about 0.25% to about 0.75%, and from about 0.4% to about 0.6% of a thickener (see Tables 2-3 below). In an illustrative embodiment, the base composition may comprise, consist essentially of, or consist of 0.5%, about 0.5%, or 0.5% or less of thickener.

Illustrative thickeners that may be added to the base composition of the present disclosure, include but are not limited to agar, pectin, arracacha flour, plantain flour, banana flour, banana yogurt, banana puree, locust bean gum “carob,” cassava powder, ground chia seeds, tapioca starch, ground flaxseed, chicory root extract, xantham gum, guar gum, arrow root starch, corn starch, and combinations thereof. In an exemplary embodiment, the thickener is pectin.

In another exemplary embodiment, the thickener is plantain flour. Unlike, banana flour (e.g., green and/or yellow banana flour), plantain flour is not a common source of starch (e.g., resistant starch) currently used in the food industry outside of baking. Current use of plantain flour in the food industry remains limited to use as a gluten-free flour replacement in baking or cooking. However, plantain flour has not been known to date to be used as a thickener in non-dairy fermented food, snack, and/or beverage products, such as a yogurt alternative.

Plantain flour added to the base composition of the present disclosure promotes improved thickening, stability, and texture of the base. The addition of the plantain also improves the flavor/taste development and delivery of the base composition to the consumer. A particular advantage of the use of plantain flour as a thickener of the base composition is that multiple thickeners are not required.

In other words, in one embodiment of the base composition, the plantain flour is the only thickener used in the base composition. Therefore, in one embodiment of the base composition, only one thickener or no more than one thickener is added (e.g., plantain flour). In another embodiment of the base composition, plantain flour may be used with no more than one additional thickener. Therefore, in another embodiment, only two thickeners or no more than two thickeners are added to the base composition. A typical embodiment of the base composition will comprise, consist essentially of, or consist of no more than one or two different thickeners.

The plant-based non-dairy fermented base composition of the present disclosure may also comprise, consist essentially of, or consist of about 0.01% to about 10% (w/w) of a sugar source (see Table 1 below). More specifically, the base composition of the present disclosure may comprise from about 0.05% to about 9%, from about 0.1% to about 8%, from about 0.15% to about 7%, from about 0.2% to about 6%, from about 0.25% to about 5%, from 0.3% to about 4%, from 0.35% to about 3.8%, from 0.4% to about 3.5%, from 0.45% to about 3.3%, from 0.5% to about 3%, from about 0.5% to about 2.5%, and from about 1% to about 2% of a sugar source (see Tables 1-3 below). In an illustrative embodiment, the base composition comprises, consists essentially of, or consists of about 1.5%, 1.5%, or about 1.5% or less of the sugar source.

A sugar or a sugar source include, but are not limited to a disaccharide, a monosaccharide, a polysaccharide, or an oligosaccharide sugar. An illustrative disaccharide sugar or sugar source of the present disclosure includes, but is not limited to sucrose. An illustrative monosaccharide sugar of the present disclosure includes, but is not limited to glucose, fructose, or combinations thereof.

Thus, a sugar (e.g., in the medium) and/or a sugar source of the base composition comprises, consists essentially of, or consists of glucose, fructose, dextrose, sucrose, and/or galactose. The sugar and/or sugar source of the base composition may also comprise any other simple or complex sugars used in production of food, snack, and/or beverage products. An illustrative embodiment of the sugar and/or the sugar source of the base composition is cane sugar.

Cane sugar of the base composition may be in different forms, including, but not limited to evaporated cane sugar, such as in a crystalline dextrose powder form (e.g., Dextrodyne). Another embodiment of the cane sugar source of the base composition includes, but is not limited to granulated cane sugar. In another embodiment of the base, granulated cane sugar replaces evaporated cane sugar as the sugar source, such that granulated cane sugar is the only sugar source for the base composition.

This granulated cane sugar source embodiment of the base comprises pure (100%) sucrose. The sucrose comprises a ratio of 45:55 fructose: glucose. The live bacteria of the starter culture comprise an enzyme (e.g., invertase) that is able to cleave the fructose: glucose bonds. The free glucose is then metabolically converted to lactic acid by the live bacteria (e.g., live lactic acid bacteria) of the starter culture. Specifically, the majority of the cane sugar source may remain as free fructose, which may be converted to glucose and then to lactic acid by the live bacteria of the starter culture.

Importantly, the base composition of the present disclosure comprises, consists essentially of, or consists of about 0.001% to about 1% of the starter culture (see Table 1 below). More specifically, the base composition may comprise from 0.001% to about 0.5% about, 0.005% to about 1%, from about 0.003% to about 0.1%, about 0.005% to about 0.05% of the starter culture, and typically from about 0.005% to about 0.05%, from about 0.005% to about 0.04%, from about 0.005% to about 0.03%, from about 0.0075% to about 0.025%, from about 0.005% to about 0.024%, from about 0.005% to about 0.025%, and from about 0.001% to about 0.023%, from about 0.001% to about 0.022%, 0.022%, about 0.022%. 0.022% or less, 0.011%, about 0.010%, about 0.011%, or about 0.010% or less of a starter culture (see Table 1 below). For example, an illustrative starter culture of the present disclosure may comprise, consist essentially of, or consist of one or more units of starter culture.

More than one unit (i.e., a plurality) of starter culture is generally required to establish and grow a healthy colony or culture of live bacteria, and any amount or concentration of starter culture that is able to establish and grow a healthy colony or culture of live bacteria is sufficient for the present disclosure. For example, a plurality of units of starter culture used to establish a stable fermentation culture generally ranges from about 20 to about 200,000. Alternatively, an existing culture may be used as the starter culture rather than growing the starter culture.

The plurality of units of starter culture of the present disclosure typically comprise, consist essentially of, or consist of live bacteria only. Live bacteria do not generally have the same ability as live yeast to metabolize sugar to produce ethanol. Instead, live bacteria typically metabolize sugar to produce acid. Specifically, lactic acid bacteria typically metabolize sugar to produce lactic acid. Other bacteria may metabolize sugar to produce different acids. For example, Acetobacter may metabolize sugar to produce acetic acid. However, collectively, the different strains of live bacteria of the starter culture must be able to convert sugar in order to produce lactic acid, even if other acids are produced by additional and/or different bacteria also present in the starter culture Thus, the starter culture and/or base composition of the present disclosure may comprise, consist essentially of, or consist of live lactic acid bacteria.

Again, one embodiment of the base composition of the present disclosure comprises a starter culture that does not comprise, consist essentially of, or consist of live yeast at all (i.e., 0% live yeast). Such embodiments of the base composition comprise a starter culture that comprises, consists essentially of, or consists of live bacteria only. In another embodiment, the base composition comprises a starter culture that comprises, consists essentially of, or consists of live bacteria and yeast components that are not living, such as nutrients, peptides, amino acids, nucleic acids, and other compositions derived from yeast that are no longer living.

The starter culture of live bacteria may comprise any amount or concentration of active units of live bacteria that are able to establish and grow a healthy colony or culture of live bacteria. More specifically, the inoculation rate of starter culture of live bacteria of the present disclosure may range from about 0.01% to about 0.05% of starter culture having a strength of about 1×10⁵ to 1×10⁸ CFU/g (colony forming units per gram) of active units of live bacteria per liter of medium. Preferably the starter culture comprises from about 5×10⁵ to about 5×10⁶ CFU/g of active units of culture.

Typically, the total active units of live bacteria in the starter culture are produced by active units of one or more different strains of live bacteria. The starter culture of the present base composition may comprise 1 to 50 different strains of live bacteria. For example, the starter culture of the present disclosure may comprise 1 to 40, 1 to 30, 1 to 20, 1 to 10, 1 to 9, 1 to 8, 1 to 7, 1 to 6, 1 to 5, 1 to 4, 1 to 3, 1 to 2, 2 to 10, 2 to 9, 2 to 8, 2 to 7, 2 to 6, 2, to 5, 2 to 4, 2 to 3, 3 to 10, 3, to 9, 3 to 8, 3 to 7, 3 to 6, 3 to 5, 3 to 4, 4 to 10, 4 to 9, 4 to 8, 4 to 7, 4 to 6, 4 to 5, 5 to 10, 5 to 9, 5 to 8, 5 to 7, 5 to 6, 6 to 10, 6 to 9, 6 to 8, 6 to 7, 7 to 10, 7 to 9, 7 to 8, 8 to 10, 8 to 9, 9 to 10, and at or about five (5) different strains of live bacteria.

In one embodiment, the live bacterial strains of the starter culture comprise, consist essentially of, or consist of the following five (5) strains: Streptococcus thermophiles, Lactobacillus delbrueckii subsp. Bulgaricus, Lactobacillus acidophilus, Lactobacillus paracasei subsp., and Bifidobacterium animalis. In another embodiment, the starter culture comprises the same five (5) bacterial strains (i.e., Streptococcus thermophiles, Lactobacillus delbrueckii subsp. Bulgaricus, Lactobacillus acidophilus, Lactobacillus paracasei subsp., and Bifidobacterium animalis) with no live yeast present in the starter culture. An illustrative embodiment of the starter culture of the base composition of the present disclosure is commercially available for purchase as YF-L02 (YoFlex-02™) from Chr. Hansen. Additional embodiments of commercially available starter cultures include, but are not limited to KEFIRAN™, Danisco ® plant-based VEGE Cultures (DuPont), and/or a probiotic strain (e.g., Lp299v from Probi).

The plant-based non-dairy fermented base composition of the present disclosure may optionally comprise a protein source. In one embodiment, the base composition of the present disclosure does not comprise a protein source (i.e., 0% protein source). In another embodiment, the base composition of the present disclosure does comprise a protein source.

The base composition of the present disclosure comprises, consists essentially of, or consists of about 0% to about 15% of the protein source (see Table 1 below). Base composition embodiments may comprise, consist essentially of, or consist of about 15% or less, 14% or less, 13% or less, 12% or less, 11% or less, 10% or less, 9% or less, 8% or less, 7% or less, 6% or less, 5% or less, 4% or less, 3% or less, 2% or less, or 1% or less of a protein source. Further, the base composition may comprise from about 0.05% to about 15%, from about 0.1% to about 14%, from about 0.5% to about 13%, from about 1% to about 12%, from about 0.2% to about 11%, from about 0.3% to about 10%, from about 0.4% to about 9%, from about 5% to about 10%, and from about 7% to about 9% of a protein source (see Table 2-3 below). In an illustrative embodiment, the base composition may comprise, consist essentially of, or consist of 8% or about 8% of the protein source.

A protein source of the base composition may be any composition known or used in the art to increase the protein content and/or concentration of an edible composition. More specifically, the protein source is added to the base composition to increase the protein content in the base composition and/or the final food, snack, and/or beverage product to a protein content ranging between about 1 grams (g) to about 20 g of protein per serving. For example, the protein source should help increase the final protein content of the food, snack, and/or beverage product to range between from about 2 g to about 19 g, from about 3 g to about 18 g, from about 4 g to about 17 g, from about 5 g to about 16 g, and from about 6 g to about 15 g per serving.

Any form of the protein source may be used in the base composition of the present disclosure. For example, the protein source may be in a form that includes, but is not limited to a milk, a butter, a paste, a powder, a flour, an isolate, a liquid, a gel, a cube (e.g., a bullion), a tablet, a puree, a yogurt, etc. An exemplary form of the protein source is a powder.

Illustrative protein sources that may be added to the base composition of the present disclosure are plant-based. For example, protein sources of the base composition include, but are not limited to proteins derived and/or originating from almonds, chia seeds, flax, peas, rice, soy, maize, or combinations thereof. In an exemplary embodiment, the protein source is pea protein.

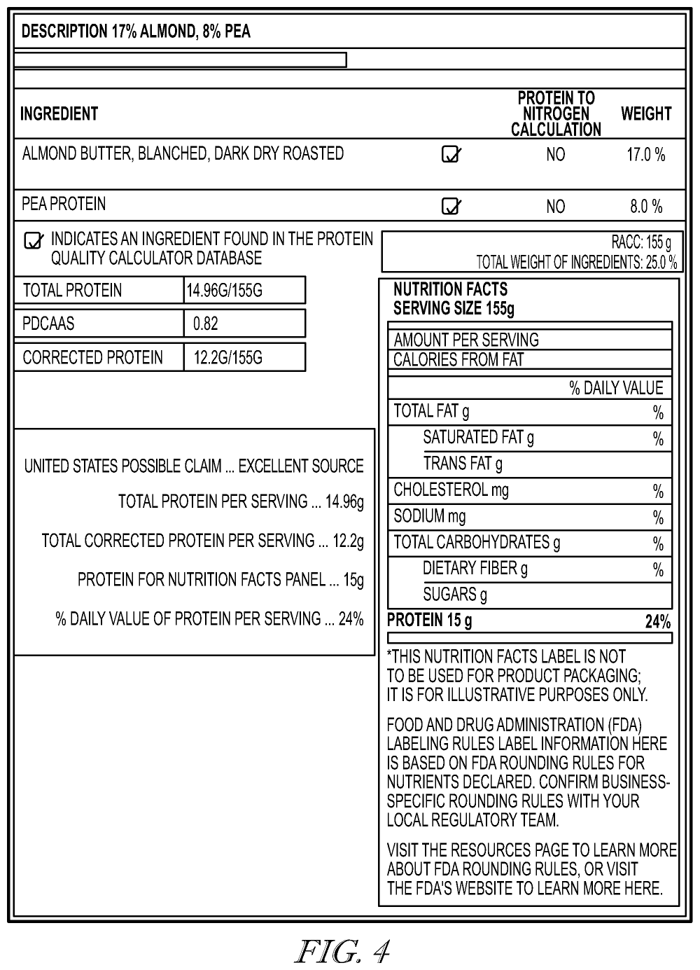

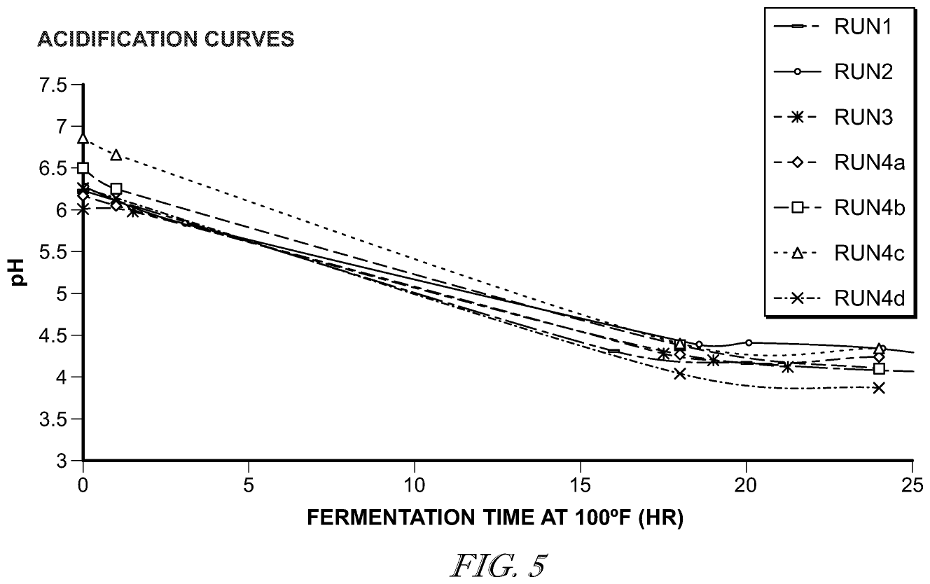

Addition of the protein source to the base composition may increase the protein content of the final food, snack, and/or beverage product by over 5%, over 10%, over 15%, over 16%, over 17%, over 18%, over 19% per serving compared to base compositions not comprising the protein source (see Tables 2 and 3 below). More specifically, the addition of the protein source to the base composition may increase the protein content and/or concentration of the protein in the food, snack, and/or beverage product to a range of about 3% to about 30%, from about 4% to about 28%, from about 5% to about 26%, from about 6% to about 24%, from about 10% to about 35%, from about 15% to about 30%, from about 20% to about 30%, and from about 20% to about 25% per serving (see Table 3 below and FIGS. 4 and 5).

Finally, the plant-based non-dairy fermented base composition of the present disclosure may optionally comprise additional components. More specifically, the base composition may also comprise, consist essentially of, or consist of one or more additional components, such as one or more enhancers. Enhancers of the base composition comprise any composition, component, and/or action used to enhance the efficiency, precision, accuracy, productivity, characteristics, and/or features, including advantageous features or characteristics of the methods (e.g., fermentation) and/or compositions (e.g., the base compositions) of the present disclosure.

More specifically, the base composition of the present disclosure may comprise, consist essentially of, or consist of about 0.01% to about 10% of the one or more enhancers. Illustrative embodiments of the base composition may comprise from about 0.01% to about 8%, from about 0.01% to about 6%, from about 0.01% to about 7%, from about 0.01% to about 5%, from about 0.01% to about 4%, from about 0.01% to about 3%, from about 0.01% to about 2%, from about 0.01% to about 1%, from 0.01% to about 0.5%, from 0.01% to about 0.25%, from 0.01% to about 0.1%, from 0.01% to about 0.05%, about 0.02%, about 0.03%, about 0.04%, about 0.05%, about 0.06%, about 0.07%, about 0.08%, about 0.09%, and about 0.1% of the total of one or more enhancers (see Table 1 below). Composition and/or components that may be added to the base composition as enhancers include, but are not limited to flavorings or flavoring agents, surfactants, adjuvants, excipients, dispersants, emulsifiers, colorings, additives, probiotics, minerals, a nitrogen source, etc.

For example, the base composition of the present disclosure may further comprise minerals. The minerals may be in the form of a mineral blend to aid the properties of the medium (e.g., water) of the base composition. The mineral blend may comprise, consist essentially of, or consist of fructo-oligosaccharides (or FOS) and/or a form of nutritive minerals, such as crude minerals or refined minerals. The mineral blend typically comprises, consists essentially of, or consists of minerals including, but not limited to calcium chloride, magnesium chloride, manganese, and potassium bicarbonate. The base composition of the present disclosure may comprise, consist essentially of, or consist of about 0.001% to about 5%, from about 0.001% to about 4%, from about 0.001% to about 3%, from about 0.001% to about 1%, from 0.001% to about 0.5%, from 0.001% to about 0.25%, from 0.001% to about 0.1%, from 0.001% to about 0.05%, about 0.002%, about 0.003%, about 0.004%, about 0.005%, about 0.006%, about 0.007%, about 0.008%, about 0.009%, and about 0.01% of the mineral blend.

For example, the base composition of the present disclosure may also comprise, consist essentially of, or consist of a nitrogen source. Illustrative embodiments of nitrogen sources of the present disclosure include, but are not limited to a form of nutritive yeast, a yeast extract, a plant-based protein extract, an isolate, or a protein concentrate.

The base composition may also comprise, consist essentially of, or consist of one or more flavoring agents. The base may comprise, consist essentially of, or consist of about 0.05% to about 4%, from about 0.05% to about 3%, from about 0.05% to about 2%, and from about 0.05% to about 1%, from about 0.05% to about 0.9%, from about 0.05% to about 0.85%, from about 0.05% to about 0.9%, from about 0.5% to about 0.9%, about 0.8%, about 0.85%, about 0.9%, and about 1% total of any one or more flavoring agents.

Flavoring agents of the present disclosure may comprise any natural and/or artificial compositions or components used in the food, snack, and/or beverage arts to add and/or enhance the flavor of a product safe for human ingestion. More specifically, illustrative flavoring agents of the base composition of the present disclosure include, but are not limited artificial flavors of vegetables, fruits, berries, melons, citrus, herbs, etc. For example, illustrative flavoring agents of the base composition of the present disclosure include, but are not limited to natural and/or artificial flavorings of ginger, lemon, fig, apple, strawberry, mint, vanilla, pineapple, coconut, mango, blueberry, raspberry, mojito, and/or orange.

Another optional flavoring agent that may be added to the plant-based non-dairy fermented base composition of the present disclosure is one or more natural fruits, herbs, and/or vegetables, including juices, pieces, portions, syrups, and/or extracts thereof. Fruits, herbs, and vegetables of the present disclosure may comprise any fruits, herbs, and/or vegetables that may be used in food, snack, and/or beverage products and that are safe for ingestion by subjects, such as humans. Generally, the amount of natural fruits, herbs, vegetables, and/or extracts thereof added to the base composition of the present disclosure ranges from about 0.01% to about 1%, and generally from about 0.01% to about 0.5%, from about 0.02% to about 0.48%, and often about 0.025% to about 0.5%.

Fruits, herbs, and vegetables include, but are not limited to whole fruits, herbs, and/or whole vegetables, as well as pieces or portions of whole fruits, herbs, and/or whole vegetables, including, but not limited to pulp, leaves, flowers, seeds, berries, stems, skin/rind, etc. Illustrative fruits of the present disclosure include, but are not limited to figs, dates, grapes, cherries, tomatoes, apples, berries (e.g., strawberries, raspberries, blueberries, acai berries, etc.), melons (e.g., watermelon, cantaloupe, honeydew melon, etc.), coconut, citrus (oranges, lemons, limes, pineapple, etc.), and others. An exemplary fruit of the present disclosure is one or more whole figs (e.g., a plurality of whole figs). Illustrative vegetables of the present disclosure include, but are not limited to kale, spinach, broccoli, peppers, etc. Illustrative herbs of the present disclosure include, but are not limited to acai, cayenne, ginger, turmeric, basil, oregano, astragalus, etc.

Natural fruit and/or vegetable extracts that may specifically be used as flavoring agents of the present disclosure comprise compositions extracted from whole, pieces, and/or portions of fruits and/or vegetables, such as fruit juice or fruit pulp, or any other downstream products made from fruit and/or vegetables extracts. For example, fruit syrup or fruit puree, often made from juice extracted from whole or portions of fruits and/or vegetables, is an illustrative example of an optional enhancer component of the base composition of the present disclosure.

An additional enhancer that may be added to the base composition of the present disclosure is a salt. Any salt used in food, snack, and/or beverage processes may be added to the base composition of the present disclosure. In one embodiment, the base of the present disclosure does not comprise a salt.

Another enhancer that may be comprised in the base composition of the present disclosure may comprise, consist essentially of, or consist of a yeast extract. Yeast extract is not and does not comprise live yeast. Instead, yeast extract is often a lysate of cells from yeast strains, including, but not limited to Saccharomyces (e.g., Saccharomyces cerevisiae). Typically, the cells of the yeast extract are dried (e.g., spray-drying) so as to produce a powder. While any form of yeast extract may be used (i.e., tablet, powder, liquid, etc.) as a fermentation enhancer of the present disclosure, a powdered yeast extract is an illustrative embodiment of the yeast extract component.

Yeast extracts add nutrients and vitamins necessary to promote and/or improve microbial growth, particularly B-complex vitamins, which are almost completely conserved in yeast extract. Therefore, yeast extract may optionally be added to the base composition of the present disclosure as a protein and/or amino acid source to feed the live bacteria in the starter culture. In particular, the yeast extract serves as a food source for live bacteria. However, in some embodiments of the present disclosure, yeast extracts are not present, used, and/or required in the starter culture and/or base composition at all.

If optional enhancer components are added to the base composition of the present disclosure, the total concentration of the optional enhancer components comprise no more than about 5% or about 10% of the total plant-based non-dairy fermented base composition. More specifically, such enhancer components comprise from about 5% or less, 4% or less, 3% or less, 2% or less, 1.5% or less, from about 0.5% to about 1.5%, from about 1% to about 1.5%, and about 1%, about 1.05%, or about 1.5% of the total base composition.

For example, enhancers may be added to affect the final sugar content of the base composition. Typically, the plant-based non-dairy fermented base composition of the present disclosure may have a high sugar concentration that may be diluted to provide a final working concentration of sugar in the composition that ranges from about 50 Brix (° Bx) to about 1° Bx. More specifically, the concentration of sugar in the base composition of the present disclosure may comprise a range of about 40 to 1° Bx, 30 to 1° Bx, 25 to 1° Bx, 20 to 1° Bx, 15 to 1° Bx, 10 to 1° Bx, and 5 to 1°Bx, 50 to 2 ° Bx, 40 to 2° Bx, 30 to 2° Bx, 25 to 2° Bx, 20 to 2° Bx, 25 to 2° Bx, 20 to 2° Bx, 5 to 2° Bx, and 2.25 to 2° Bx.

Notably, sugar concentrations that are too high may kill off any live bacteria necessarily present in the starter culture and/or base composition of the present disclosure, and thus prevent fermentation from occurring. For example, starter cultures and/or base compositions comprising a concentration of sugar ranging from 51° Bx or higher, such as 51° Bx to 100° Bx, 60° Bx to 100° Bx, 70° Bx to 100° Bx, 80° Bx to 100° Bx, 90° Bx to 100° Bx, and certainly 100° Bx may comprise sugar concentrations that are toxic and/or fatal to the live bacteria. Thus, fermentation does not occur at all or does not properly occur at such high sugar concentrations as required to produce the base composition of the present disclosure.

When the base components are combined and/or mixed together, they produce a slurry. The slurry of the base composition may comprise, consist essentially of, or consist of the medium, the sugar source, the substrate, and the thickener in amounts described for the base composition. The slurry may further comprise the protein source, minerals or the mineral blend, water, and/or any additional or optional components including, but not limited to the enhancers as also described herein for the base composition. The starter culture is then combined with and/or mixed into the slurry and processed (e.g., fermented) in order to produce the plant-based non-dairy fermented base composition of the present disclosure.

The base composition may then be included in food, snack, and/or beverage products for ingestion by subjects, such as humans. Illustrative food, snack, and/or beverage products comprising the plant-based non-dairy fermented base composition may be in various forms, including, but not limited to food, snacks, elixirs, shots, shooters, spoonables, spreadables, drinkables, smoothies, shakes, soups, and beverages. An exemplary form of the food, snack, and/or beverage products comprising the plant-based non-dairy fermented base composition is a spoonable, spreadable, and/or drinkable product.

Illustrative spoonable products comprising the plant-based non-dairy fermented base composition of the present disclosure include, but are not limited to nutritional food and/or snack products, such as foods that affect and/or improve dietary, gut, and/or gastrointestinal health of a subject (e.g., a human). More specifically, spoonable food and/or snack products comprising the based composition include, but are not limited to yogurt, dips, sauces, creams, pudding, ice cream, soups, etc. An exemplary spoonable food and/or snack product comprising the plant-based non-dairy fermented base composition of the present disclosure is a spoonable yogurt and/or a spoonable non-dairy yogurt alternative. Notably, there is no plantain flour yogurt alternative comprising live and/or active cultures currently available on the market. Exemplary spreadable or squeezable food and/or snack products comprising the plant-based non-dairy fermented base composition of the present disclosure include, but are not limited to dips, spreads, cheeses, creams, jellies, jams, pâté, hummus, icings, glazes, frostings, condiments, etc. An exemplary spreadable food and/or snack product comprising the plant-based non-dairy fermented base composition of the present disclosure is a spreadable or squeezable yogurt and/or a spreadable or squeezable non-dairy yogurt alternative.

Illustrative drinkable snack and/or beverage products comprising the plant-based non-dairy fermented base composition of the present disclosure include, but are not limited to water, juices, sodas, smoothies, shakes, teas, kombuchas, lemonades, coffees, frappes, lattes, cappuccinos, probiotic drinks, tonics, etc. An exemplary drinkable beverage and/or snack product comprising the plant-based non-dairy fermented base composition of the present disclosure is a drinkable yogurt and/or a drinkable non-dairy yogurt alternative.

In addition, the plant-based non-dairy fermented base composition of the present disclosure may comprise from about 15% to about 100% of a food, snack, and/or beverage product, particularly a food, snack, and/or beverage product for commercial and/or retail sale. More specifically, the base composition of the present disclosure may comprise about 20% to about 95%, from about 25% to about 90%, from about 30% to about 80%, from about 40% to about 75%, from about 75% to about 100%, from about 60% to about 90%, and from about 50% to about 75% of a food, snack, and/or beverage product of the present disclosure.

Additionally, the food, snack, and/or beverage products comprising the base composition of the present disclosure include, but are not limited to food, snack, and/or beverage products that labeled and/or designated as non-dairy, no-soy, lactose-free, GRAS, food grade, allergen free, certified organic or “organic,” kosher, vegan, clean-label, and non-GMO. The food, snack, and/or beverage product comprising the plant-based non-dairy fermented base composition of the present disclosure does not sacrifice any health benefits of its “organic” profile and also provides similar sensory qualities as products produced via prior art methods of fermentation.

TABLE 1

| | | | i. | ii. | iii. |
|---|---|---|---|---|---|
| | | | % Ranges in | % in BASE | % in BASE |
| | | Ingredients | BASE | Embodiment I | Embodiment II |
| Base | Slurry | Substrate (e.g., Almond Butter) | 1-40% | 12-25% | 15-20% |
| | | Protein Source (e.g., Pea Protein) | 0-15% | 0-10% | 5-10% |
| | | Thickener (e.g., Plantain Flour) | 0.1-5% | 0.2-2% | 0.3-1% |
| | | Sugar Source (e.g., Cane Sugar) | 0.1-10% | 0.5-3% | 1-2% |
| | | Medium added to form BASE | 30-99% | 60-95% | 70-85% |
| | | (e.g., Water) | | | |
| | | Enhancer(s) | 0-10% | 0-5% | 0-1% |
| | | Starter Culture | 0.005-1% | 0.005-0.050% | 0.005-0.025% |
| | | TOTAL BASE COMPOSITION | 100% | 100% | 100% |

### METHODS OF THE PRESENT DISCLOSURE

The present disclosure is also directed to methods of making and/or using the plant-based non-dairy fermented base composition described above. More specifically, the present disclosure is directed to a method of making the plant-based non-dairy fermented base composition of the present disclosure and/or a process of using the plant-based non-dairy fermented base composition of the present disclosure. In particular, the method of making the plant-based non-dairy fermented base composition of the present disclosure comprises, consists essentially of, or consists of the process of fermentation. In addition, the present disclosure is directed to a method of fermenting the plant-based non-dairy base composition.

Generally, “fermentation” or the process of “fermenting” refers to the metabolic process where carbohydrates, such as sugars, are metabolized by enzymes within “live yeasts” and/or “live bacteria” in a starter culture and converted into acids (e.g., lactic acid), gases (e.g., carbon dioxide), alcohols (e.g., ethanol), and/or energy (e.g., ATP). In particular, fermentation of sugar by “live bacteria” in the current method of making the base composition includes adding the components of the base composition in order to form a slurry or a mixture.

The plant-based non-dairy fermented base composition of the present disclosure may be produced by the combination of the substrate, the sugar source, the medium, the thickener, and any optional components (e.g., a protein source) or additional enhancer components (e.g., a flavoring agent) to form a slurry. More specifically, the components of the slurry comprise, consist essentially of, or consist of the medium, the substrate, the sugar source, the thickener, and optionally, the protein source and the one or more enhancers. As described in more detail below, the base components of the slurry may be further combined and mixed with the starter culture. Fermentation of the substrate in the medium of the slurry by the live bacteria of the starter culture occurs to produce the plant-based non-dairy fermented base composition

Typically, the other components of the slurry are added to the liquid medium (e.g., water). Alternatively, the medium (e.g., water) may be added to the other components of the slurry. Further, the medium may be warm or hot having a temperature ranging from about 18° C. to about 37.5° C. in order to aid dissolution, homogenization, and/or concentration of the slurry components. In some embodiments, the medium of the slurry is water, including warm water or hot water.

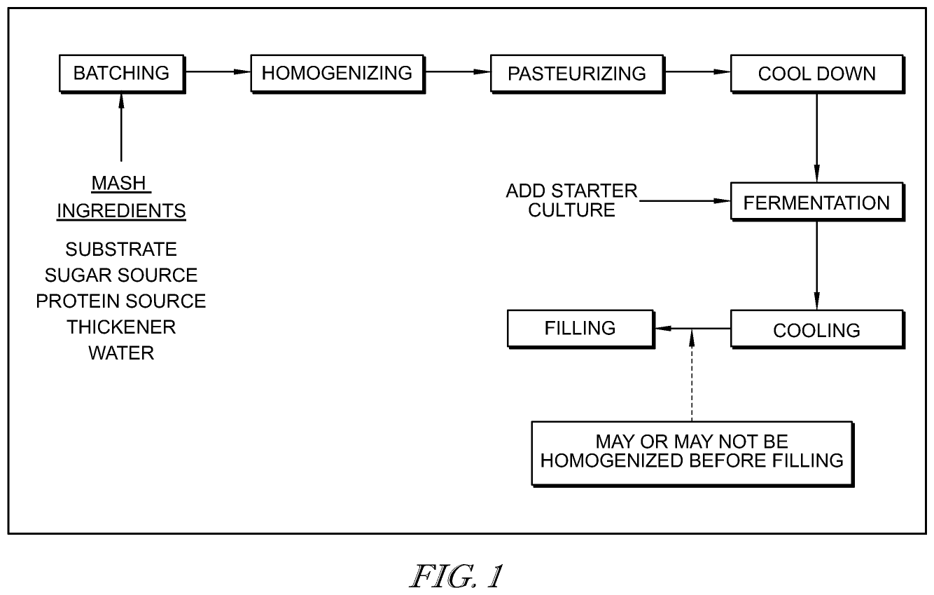

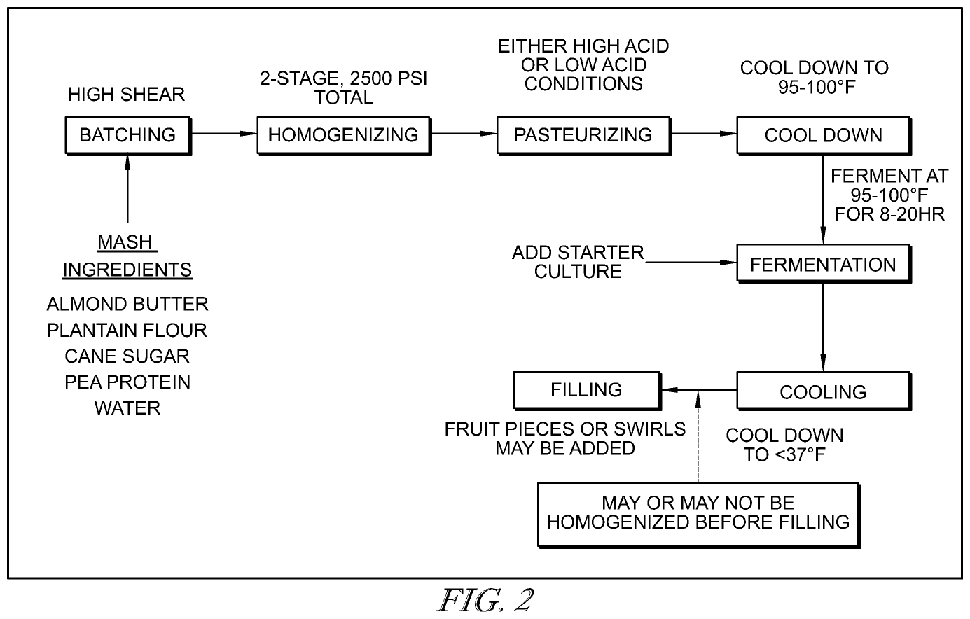

The slurry may be mixed, sheared, homogenized, and/or concentrated (see FIGS. 1 and 2). More specifically, the medium, (e.g., water), the substrate, the sugar source, the thickener, and optionally, the protein source and the one or more enhancers may be mixed, sheared (e.g., high shear), concentrated, and/or homogenized by any methods known in the art. For example, homogenization of the slurry may occur using a 2-stage method known in the art comprising a pressure of about 2500 psi total (see FIG. 2). While mixing, shearing, concentrating, and/or homogenization of the slurry typically occurs prior to fermentation, such processes may also occur during and/or after fermentation, if necessary and/or desired.

In some embodiments of the present methods of making, producing, and/or fermenting the plant-based non-dairy base composition, the methods may optionally comprise, consist essentially of, or consist of one or more sterilization and/or sanitization processes to eliminate harmful microbes. Illustrative sterilization processes of the present methods include, but are not limited to pasteurization and/or irradiation. An illustrative embodiment of an irradiation method comprises ultraviolet (UV) light treatment.

While UV light treatment may be performed at any wavelength sufficient to eliminate (e.g., kill) microbes from the slurry and/or base compositions, the exemplary process to eliminate pathogenic microorganisms from the slurry and/or base composition of the present disclosure is pasteurization. For example, once mixed, sheared, homogenized, and/or concentrated, the slurry composition may then be further irradiated and/or pasteurized in order to kill and/or eliminate any harmful microorganisms and therefore, sterilize the slurry and/or base composition and the downstream food, snack, and/or beverage product. In an exemplary method, the slurry and/or base composition is pasteurized.

Often, the pasteurization process occurs in a tubular or plate heat exchanger comprising a hold tube where the slurry composition may be held for about 30 seconds to about 120 seconds at a target pre-determined temperature that is usually above 200° F. In some embodiments, the pasteurization of the slurry occurs at high acid conditions (e.g., pH of 4.6 or less). Illustrative high acid conditions occur at pH 4.2 and below. In an illustrative embodiment, pasteurization will occur at pH 4.2 and below where the slurry is heated above a temperature of 200° F. and held at that temperature for at least 30 seconds. Conversely, in some embodiments, the pasteurization of the slurry may occur at low acid conditions (e.g., pH greater than 4.6 to about 7).

As mentioned, the pasteurization process is typically conducted at a minimum heat temperature at, about, or above 93.4° C. (i.e., about 200° F.). For example, the slurry may be heat pasteurized to kill any pathogenic microbes at a temperature ranging from about 93.4° C. to about 135° C., from about 93.4° C. to about 125° C., from about 93.4° C. to about 115° C., from about 93.4° C. to about 105° C., from about 93.4° C. to about 100° C., from about 93.4° C. to about 99° C., from about 93.4° C. to about 98° C., from about 93.4° C. to about 97° C., from about 93.4° C. to about 96° C., from about 93.4° C. to about 95° C., from about 93.4° C. to about 94.4° C., and finally at, about, or above 93.4 ° C. or 94.4° C.

The slurry may be heat pasteurized for any amount of time sufficient to eliminate microbial pathogens. Typically, the time period for pasteurization of the slurry composition ranges from about 120 to about 480 seconds, from about 120 to about 240 seconds, and often at about 120 seconds. In some embodiments, a minimum of at least about 120 seconds of heat exposure is required for sufficient pasteurization of the slurry and/or base composition of the present disclosure.

After heat pasteurization, the slurry may be cooled down to a temperature ranging from about 35° C. to about 40° C. (i.e., 95-104° F. or below). At this step, the starter culture may be added to the cooled and pasteurized slurry. The starter culture may be added to the slurry in order to begin the fermentation process via slow to medium mixing (see FIGS. 1 and 2).

The slurry may be combined with the starter culture comprising ‘live bacteria” in order to form a mixture. More specifically, the starter culture may be inoculated onto or into a liquid medium (e.g., water) at any concentration that supports the establishment and growth of a stable colony or culture of live bacteria and/or fermentation by the live bacteria. In some embodiments, the live bacteria are inoculated into the liquid medium at a concentration ranging from about 0.002% to 0.05% of starter culture (at a strength/concentration of 1×10⁹ to 1×10¹¹ CFU/g) per liter of medium. This equates to 500 g of starter culture (at a strength/concentration of 1×10⁵ to 1×10⁸ CFU/g) for 5000 L of medium or 1 gram of starter culture (at a strength/concentration of 1×10⁵ to 1×10⁹ CFU/g) for 10 L of medium.

The slurry should be at proper temperature prior to starter culture addition to form a mixture. However, fermentation time will have started once the starter culture is added to the water. Monitoring of the inoculation rate during start-up is helpful, but may be switched to periodic monitoring once the fermentation process is consistent.

Once the slurry and/or medium are inoculated with the live bacteria of the starter culture, the mixture is placed in an atmosphere to promote metabolism and fermentation. Typically, the fermentation process of the present disclosure occurs at anaerobic conditions to promote the production of lactic acid, or lactate, which is lactic acid in solution. The presence of oxygen in any significant amount above anaerobic conditions often kills the live bacteria used for fermenting the mixture of the present disclosure. Thus, the method of making, producing, and/or fermenting the base composition of the present disclosure is typically conducted or occurs in one or more sealed, air-tight containers to promote an anaerobic environment and to prevent the contamination by environmental pathogens.

Any sealed, air-tight container used in the food, snack, and/or beverage industry, particularly the commercial food, snack, and/or beverage industry, will suffice to promote the anaerobic environment used in the present process of fermentation. Illustrative sealed, air-tight containers to conduct the present methods include, but are not limited to containers made of glass, metal, plastic, polypropylene, polystyrene, etc. Exemplary embodiments of the form or shape of containers that may be used for the present methods include, but are not limited to bottles, beakers, cups, jars, dishes (e.g., petri dish), bowls, etc.

An illustrative container of the present disclosure is a tank. The tank of the present disclosure may be sealable or unsealable, as well as sealed or unsealed. The tank of the present disclosure may also be permeable or impermeable to gases, such as air or other gases. In one embodiment, the tank of the present disclosure is sealable, sealed, and air-tight, such that it is impermeable to gases and/or air. In an illustrative embodiment, the tank of the present disclosure is an air-tight and/or sealable tank often used in manufacturing.

Such tank may have any shape or form that provides the anaerobic environment necessary to promote fermentation and/or production of large batches of the slurry and/or base composition. Any such tank, also called batch tanks, known and/or used for the safe manufacturing of food, snack, and/or beverages may be used as a tank of the present disclosure. For example, the making, mixing concentrating, heating, cooling, pasteurizing, sterilizing, fermenting and/or producing of the slurry and/or base composition of the present disclosure may be performed in a tank or batch tank for commercial and/or industrial use.

Known as the homolactic fermentation pathway or the homofermentative process, this method of fermentation generally converts one molecule of a sugar (e.g., glucose, sucrose, dextrose, and fructose) to two molecules of lactic acid. Alternatively, carbon dioxide, hydrogen gas, and/or acetic acid, may also be produced, in addition to lactic acid, using a phosphoketolase or pentose phosphate pathway of heterolactic fermentation or the heterofermentative process. In both homofermentative and/or heterofermentative methods, live bacteria that may be incorporated into the mixture include, but are not limited to bacteria from genuses Lactobacillus, Streptococcus, Pediococcus, Lactococcus, Leuconostoc, Aerococcus, Carnobacterium, Enterococcus, Oenococcus, Sporolactobacillus, Tetragenococcus, Vagococcus, and/or Weissella. However, in both methods of homofermentation and heterofermentation, lactic acid is a primary product of the lactic acid bacterial fermentation pathway.

Illustrative fermentation conditions include placement of the mixture at a temperature ranging from about 20° C. to about 50° C., from about 30° C. to about 50° C., from about 35° C. to about 50° C., from about 25° C. to about 50° C., from about 36° C. to about 50° C., from about 25° C. to about 45° C., from about 25° C. to about 40° C., from about 30° C. to about 45° C., from about 30° C. to about 43° C., from about 30° C. to about 42° C., from about 20° C. to about 45° C., from about 30° C. to about 47° C., from about 35° C. to about 45° C., from about 35° C. to about 42° C., and from about 37.8° C. to about 40° C. (i.e., 100-104° F.), such as about 37° C. to about 38° C., and about 37.5° C. to about 38° C.

Generally, the mixture may be allowed to ferment at the fermentation temperature described above for about 4 to 48 hours in order for the fermentation process to fully complete. Often times, the fermentation process of the present disclosure is completed within about 4 to about 24 hours, from about 4 to about 12 hours, from about 4 to about 20 hours, from about 4 to about 16 hours, from about 12 to about 24 hours, from about 12 to about 20 hours, from about 14 to about 22 hours, from about 16 to about 24 hours, from about 18 to about 25 hours, from about 16 to about 22 hours, about 16 hours, about 16 hours or less, less than 16 hours, about 24 hours, 24 hours or less, less than 24 hours, about 18 hours, about 18 hours or less, less than 18 hours, at about 20 hours, 20 hours or less, less than 20 hours, at about 14 hours, 14 hours or less, less than 14 hours, and at about 12 hours, 12 hours or less, or less than 12 hours.

The present methods also comprise, consist essentially of, or consist of fermentation times that are even shorter than currently described. For example, the current processes of making, producing, and/or fermenting the base composition of the present disclosure range from about 2 hours to about 12 hours. Illustrative embodiment of the present methods may comprise fermentation times from about from about 2 hours to about 10 hours, from about 2 hours to about 8 hours, from about 8 hours to about 12 hours, from about 6 hours to about 12 hours, from about 4 hours to about 12 hours, from about 4 hours to about 10 hours, from about 8 hours to about 10 hours, and about 8 hours, about 10 hours, about 6 hours, about 4 hours, or about 8 hours or less, less than 8 hours, about 10 hours or less, less than 10 hours, about 6 hours or less, less than 6 hours, and about 4 hours or less, and less than 4 hours.

Growth and proliferation of the live bacteria also aid the metabolism and/or fermentation of the sugar by the live bacteria to produce lactic acid. Growth conditions for culturing the live bacteria correspond with any conditions known in the art for proper fermentation of sugar by live lactic acid bacteria in order to produce lactic acid.

More specifically, in one embodiment, the process of making, producing, and/or fermenting the plant-based non-dairy base composition of the present disclosure comprises adding live bacteria of a starter culture to a slurry to provide a mixture. The live bacteria metabolize the sugar in the liquid medium via the process of fermentation. The methods of making, producing, and/or fermenting the base composition of the present disclosure results in the formation and/or production of acids comprising, consisting essentially of, or consisting of lactic acid.

Rapid formation of lactic acid by the mixture of live bacteria via fermentation of the sugar in the slurry also lowers the pH of the mixture. Generally, the pH of the fermentation reaction begins at a range of about pH 5.5 to about pH 6.5, and often at or about pH 5.8, pH 5.9, pH 6.0, pH 6.1, and/or pH 6.2. However, increased formation of lactic acid reduces the pH of the fermentation mixture such that the pH ranges from about 3.8 to about 4.6, and at our about pH 3.8, pH 3.9, pH 4.0, pH 4.1, pH 4.2, pH 4.3, pH 4.4, pH, 4.5, and/or pH 4.6.

Slowing and/or stopping the fermentation process also stops the production of lactic acid. As the fermentation process slows and/or comes to a stop, sufficient lactic acid will have been produced via the fermentation process depending on the fermentation time. For example, lactic acid in the range of about 0.1% to about 1.0% is generally produced by the described methods. More specifically, the present methods produce about 0.2% to about 0.5% of lactic acid, and often about 0.3%. To slow and/or stop the fermentation process, the reaction is cooled, such as by cooling the tank.

Importantly, cooling the fermentation reaction, such as by a “chill” process, includes but is not limited to rapidly cooling the mixture tank, and the contents therein (i.e. the base or slurry composition and/or fermentation reaction), in order to aid in the slowing and/or stopping of the fermentation reaction occurring in the mixture. To slow and/or stop the fermentation process, the temperature of the fermentation will be reduced down to about 1° C. to about 20° C., such as at about 2° C. to about 18° C., about 3° C. to about 16° C., about 4° C. to about 15° C., about 4° C. to about 15° C. More specifically, the “chill” process cools the reaction to a temperature that is at or below about 2.8° C. (i.e., 37° F. or below).

The methods of making, producing, and/or fermenting the non-dairy base composition of the present disclosure, provide the ability to control the microbial cell culturing and fermentation processes utilized in order to control the output of the base composition of the present disclosure. A processing aid or other component of the base composition may be added to the mixture in order to help the structure or performance of the fermented base. For example, a component may be added to lower the pH of the mixture.

The plant-based non-dairy fermented base composition of the present disclosure is produced by the combination of the starter culture to the slurry (i.e., the mixture), along with any subsequent components added to the mixture, such as the acid to further lower the pH of the fermentation reaction. Once combined, the base composition may be included in food, snack, and/or beverage products for ingestion by subjects, such as humans. Accordingly, the present disclosure is also directed to a method of using the plant-based non-dairy fermented base composition of the present disclosure.

More specifically, a concentration ranging from about 15% to about 100% of the plant-based non-dairy fermented base composition of the present disclosure may be used to prepare food, snack, and/or beverage products, particularly food, snack, and/or beverage products for commercial retail. For example, from about 20% to about 95%, from about 25% to about 90%, from about 30% to about 80%, from about 40% to about 75%, from about 75% to about 100%, from about 60% to about 90%, and from about 50% to about 75% of the plant-based non-dairy fermented base composition of the present disclosure may be used to prepare food, snack, and/or beverage products.

In particular, illustrative food, snack, and/or beverage products comprising the plant-based non-dairy fermented base composition may be in various forms, including, but not limited to food, snacks, elixirs, shots, shooters, spoonables, spreadables, squeezables, drinkables, smoothies, shakes, soups, yogurts, and beverages. Illustrative food, snack, and/or beverage products comprising the plant-based non-dairy fermented base composition of the present disclosure have been previously described and include, but are not limited to spoonable, spreadable, squeezable, and/or drinkable yogurt embodiments. Exemplary food, snack, and/or beverage product embodiments comprising the plant-based non-dairy fermented base composition include, but are not limited to spoonable, spreadable, squeezable, and/or drinkable non-dairy yogurt alternatives.

As mentioned, the present methods may comprise, consist essentially of, or consist of live yeast, live bacteria, and the combinations thereof. Illustrative embodiments of the methods for making, producing, and/or fermenting the plant-based non-dairy base composition do not require and/or use live yeast at all. In other words, in some embodiments of the present methods, only live bacteria are used.

Elimination of the use of live yeast prevents alcohol and/or ethanol production. In addition, omission of live yeast in the present methods also prevents the production of ethanol and eliminates product cross-contamination during the production and/or manufacturing process of food, snack, and/or beverage products for retail, which provides an additional benefit.

Finally, the present methods of making, fermenting, and using the plant-based non-dairy fermented base composition of the present disclosure provide unexpected results as compared to the current method of fermentation. Further, the present methods and compositions do not require expensive ingredients. Finally, the present disclosure is directed to new and improved methods and processes for fermenting a slurry composition that is capable of producing a plant-based non-dairy base composition, which may subsequently be used to generate food, snack, and/or beverage products with improved nutritional, sensory, flavor, and/or texture characteristics. Such qualities and characteristics are particularly important for the production of food, snack, and/or beverage products for commercial retail.

### EXAMPLES

Illustrative embodiments of the compositions, components, and/or methods of the present disclosure are provided by way of examples. While the concepts and technology of the present disclosure are susceptible to broad application, various modifications, and alternative forms, specific embodiments will be described here in detail. It should be understood, however, that there is no intent to limit the concepts of the present disclosure to the particular forms disclosed, but on the contrary, the intention is to cover all modifications, equivalents, and alternatives consistent with the present disclosure and the appended claims. The following experiments were conducted to determine ingredient and nutritional functionality of the plant-based non-dairy fermented composition of the present disclosure for use in food, snack, and/or beverage products, particularly food, snack, and/or beverage products for commercial retail.

### Example 1: Base Composition Embodiment III

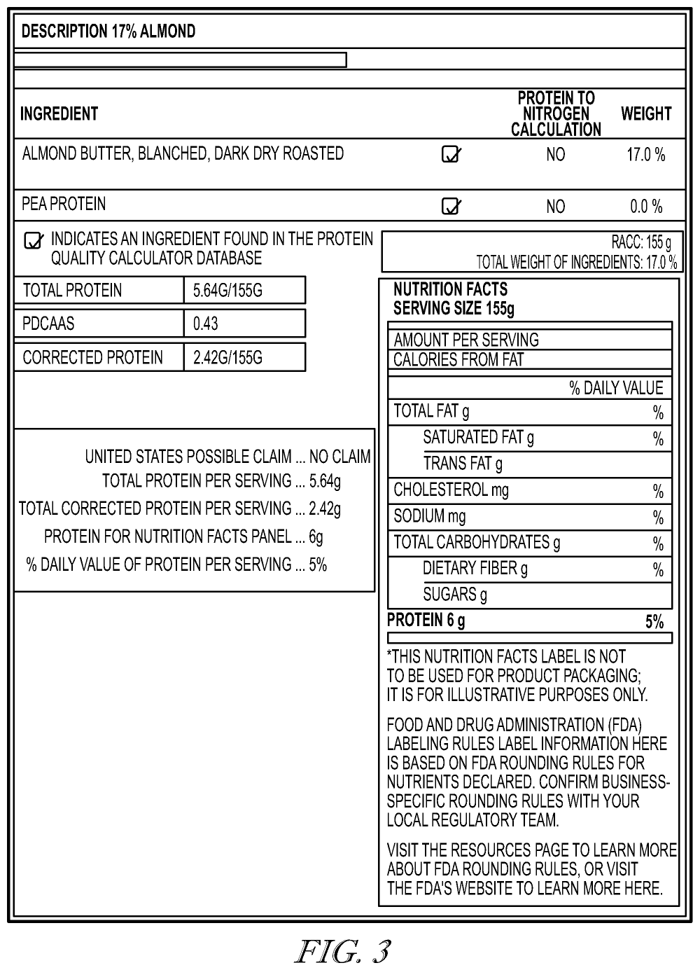

A general embodiment and two specific embodiments (i.e., Base Composition Embodiments I and II) of the base composition of the present disclosure are described in Table 1 above. The amount and/or concentration of components of a third specific base composition embodiment of the present disclosure is shown below in Table 2. Additional details regarding this base composition are shown in FIG. 3.

This third specific base composition embodiment comprises about 17% of an organic almond butter substrate (e.g., a roasted or an unroasted almond butter substrate), about 81% of a water medium, and about 1.5% of an organic cane sugar source. While this base composition embodiment comprises about 0.5% of a plantain flour thickener to form the slurry (i.e., a low-acid product), it did not comprise pectin as an additional protein source. Thus, the protein content of this base composition embodiment was about 5.6 g to about 5.65 g of protein, such as about 5.64 g, about 5.6 g, and about 6 g of protein.

### Example 2: Base Composition Embodiment IV

The concentration of components of yet a fourth base composition embodiment is shown below in Table 3. Additional details regarding this base composition are shown in FIG. 4. This fourth specific base composition embodiment comprises about 17% of an organic roasted almond butter substrate, about 73% of a water medium, and about 1.5% of an organic cane sugar source. While this base composition embodiment comprises about 0.5% of a plantain flour thickener to form the slurry, similar to the embodiment of Example 1, it did not comprise pectin as an additional protein source. However, this particular embodiment of the base composition did comprise about 8% of another protein source, namely pea protein.

Addition of the pea protein significantly increased the overall protein content of the base composition. Thus, the protein content of this base composition embodiment comprised about 14.9 g to about 16.9 g of protein, such as about 14.96 g, about 15 g, about 16.86 g, and about 16.9 g of protein. Addition of the pea protein resulted in a significant increase in protein content of the base composition compared to base composition embodiments lacking the pea protein (see Example 1 above). Further, the addition of the pea protein provided an unexpected increase in the mouthfeel, creaminess, thickness, and/or viscosity of the base composition of the present disclosure.

### Example 3: Nutritional Characteristics/Attributes of the Base Composition

The base composition of the present disclosure may comprise, consist essentially of, or consist of particular characteristics and/or attributes when made, produced, and/or fermented according to the described methods. More specifically, base compositions of the present disclosure may have particular average amounts and/or concentrations of calories, sugar, protein, fat, calcium, fiber (e.g., dietary fiber), and/or saturated fat (see Table 4 below). In addition, the base composition may have particular ranges of amounts and/or concentrations of calories, sugar, protein, fat, calcium, fiber (e.g., dietary fiber), and/or saturated fat. In addition, the particular ranges of amounts and/or concentrations (w/w %) of calories, sugar, protein, fat, calcium, fiber (e.g., dietary fiber), and/or saturated fat for Base Composition Embodiments III and IV are shown in Tables 2 and 3 above, respectively.

More specifically, the average caloric content for commercially-available yogurt alternative products was about 155 calories with a standard deviation of about 44.5 calories, and a range of about 100 calories to about 260 calories (see Table 4 below). The average sugar content of these prior art products was about 12.4 grams (g) of sugar with a standard deviation of about 5.7 g, and a range of about 1 g to about 25 g of sugar. The average protein content of the commercial products was about 5.1 g with a standard deviation of about 2.9 g, and a range of about 0.5 g to about 35 g of protein. The average fat content of these commercial products was about 7.7 g with a standard deviation of about 4.8 g, and a range of about 5 g to about 25 g of fat. The average calcium content of these prior art products was about 13.3 g with a standard deviation of about 10.1 g, and a range of about 3 g to about 33 g of calcium. The average fiber (e.g., dietary fiber) content of these commercial products was about 1.5 g with a standard deviation of about 1.3 g, and a range of about 0.5 g to about 10 g of fiber (see Table 4 below).

In an exemplary embodiment, calories for the base composition and/or product of the present disclosure may range from about 100 calories to about 300 calories. In addition, the base composition and/or product of the present disclosure may comprise, consist essentially of, or consist of from about 5 g to about 12 g protein, from about 10 g to about 12 g of sugar with about 7 g of added sugar, and from about 1 g to about 10 g of fiber.

### Example 4: Processing/Fermenting Time for the Base Composition

This final example is provided to demonstrate the improvement in making, producing, and/or fermenting the base composition of the present disclosure as compared to methods known in the art. More specifically, prior art methods to produce a fermented non-dairy base composition requires a pH below 6-8 and a dairy fermentation pH 4-6. FIG. 5 demonstrates that the current method of making, producing, and/or fermenting the non-dairy base composition of the present disclosure drives the pH down to at, about, or below about pH 3.5-4.5, such as about pH 4.5, pH 4.4, pH 4.3, pH 4.2, pH 4.1, pH 4.0, pH 3.9. pH 3.8, pH 3.7, pH 3.6, pH 3.5, or below, and in some embodiments, even lower (e.g., pH 3.4 or lower).

Current non-dairy and/or non-soy food, snack, and/or beverage alternatives on the market have a gap in texture, nutritional, organoleptic, and/or sensory (e.g., flavor) characteristics. Present non-dairy products also suffer from suboptimal nutritional delivery in humans, particularly related to the lack of protein and fat used in their base compositions (e.g., almond milk and/or coconut milk). Current non-dairy products also suffer from consumer satisfaction due to their processing. For example, some non-dairy products on the market require the addition of multiple thickening and/or stabilizing agents to deliver the necessary texture, sensory, and/or nutritional satisfaction of consumers.

In contrast, the present technology addresses the gap in current fermentation technologies in order to produce plant- and/or nut-based non-dairy food, snack, and/or beverage products that have improved sensory, nutrition, and marketing label (e.g., clean-label) characteristics. The present methods and compositions also improve the nutritional delivery of non-dairy products by incorporating the use of a substrate (e.g., almond butter) that has a higher protein content and/or delivery capacity than prior art nut milks on the market. Addition of a non-dairy starter culture to the substrate (e.g., almond butter) that has been diluted with the medium (e.g., water) initiates fermentation, and thus drops the pH of base composition. Fermenting the substrate (e.g., almond butter) generates acidification (see FIG. 5) that provides and delivers improved flavor, as well as improves the microbial safety of the base composition and the final food, snack, and/or beverage product.

In addition, the described methods and compositions may also provide an additional protein source (e.g., pea protein) to increase nutritional delivery and consumer sensory and organoleptic satisfaction. Further, addition of a thickener to the base composition of the present disclosure (e.g., plantain flour, banana puree, and/or banana flour) provides improved sensory satisfaction and nutritional delivery for consumers. Addition of a thickener (e.g., plantain flour) provides thickness and stability to the base, as well as pea protein to deliver higher protein content. Notably, the present method provides clean-label thickening of the product without any off notes in a plant-based non-dairy fermented base composition.

The addition of the thickener (e.g., plantain flour) also provides gelatinization during the heating process, which increases the thickness of the base to provide a texture that is not artificially gelatinized and pleasing to consumers. In addition to the thickening and increased nutrient delivery, the addition of the thickener (e.g., plantain flour) to the base composition also provides a resistant starch. The resistant starch of the thickener acts not only as a stabilizer, but may also provide an added benefit for digestion and nutrient absorption into the body. Further, the addition of the thickener to the base composition provides an improved, mild flavor without the need to pre-hydrate or pre-process the thickener as is required for many current thickening agents and/or thickeners in the art.

TABLE 2
Base Composition Embodiment III
No Pectin; Almond Base (5.6 g total protein)

| | | | | | | | Amount |
|---|---|---|---|---|---|---|---|
| Ingredient | % (w/w) | Calories | Fat | Sat Fat | Protein | Fiber | (g)/5.3 oz |
| Water (beverage) | 81 | 0 | 0 | 0 | 0 | 0 | 125.6 |
| Almond butter | 17 | 190 | 16 | 1.4 | 5.5 | 2.7 | 26.4 |
| (Organic Ready | | | | | | | |
| Roast) | | | | | | | |
| Sugar | 1.5 | 0 | | | | | 2.3 |
| (Organic Cane) | | | | | | | |
| Plantain | 0.5 | 5.5 | 0 | 0 | 0.1 | 0.1 | 0.8 |
| Flour | | | | | | | |
| Total | 100 | 195.5 | 16 | 1.4 | 5.6 | 2.8 | 155 |

TABLE 3
Base Composition Embodiment IV
No Pectin; Almond Base + 8% Pea Protein (16 g total protein)

| | | | | | | | Amount |
|---|---|---|---|---|---|---|---|
| Ingredient | % (w/w) | Calories | Fat | Sat Fat | Protein | Fiber | (g)/5.3 oz |
| Water (beverage) | 73 | 0 | 0 | 0 | 0 | 0 | 113.2 |
| Almond butter | 17 | 190 | 16 | 1.4 | 5.5 | 2.7 | 26.4 |
| (Organic Ready | | | | | | | |
| Roast) | | | | | | | |
| Sugar | 1.5 | 0 | | | | | 2.3 |
| (Organic Cane) | | | | | | | |
| PurisPea | 8 | 60 | 1.12 | 0 | 11.26 | 0.75 | 12.4 |
| 870 (Cargill) | | | | | | | |
| Plantain | 0.5 | 5.5 | 0 | 0 | 0.1 | 0.1 | 0.8 |
| Flour | | | | | | | |
| Total | 100 | 255.5 | 17.12 | 1.4 | 16.86 | 3.55 | 155 |

TABLE 4
Nutritional Ranges of Commercial
Products in the Current Landscape

| | | | | | | Dietary |
|---|---|---|---|---|---|---|
| | | Sugar | Protein | Fat | Calcium | Fiber |
| | Calories | (g) | (g) | (g) | (% DV) | (g) |
| AVG | 155 | 12.4 | 5.1 | 7.7 | 13.3 | 1.5 |
| STDEV | 44.5 | 5.7 | 2.9 | 4.8 | 10.1 | 1.3 |
| RANGE | 100-260 | 1-25 | 0.5-35 | 5-25 | 3-33 | 0.5-10 |

The preceding description enables others skilled in the art to use the technology in various embodiments and with various modifications as are suited to the particular use contemplated. In accordance with the provisions of the patent statutes, the principles and modes of operation of this disclosure have been explained and illustrated in exemplary embodiments. Accordingly, the present invention is not limited to the particular described and/or exemplified embodiments.

It is intended that the scope of disclosure of the present technology be defined by the following claims. However, it must be understood that this disclosure may be practiced otherwise than is specifically explained and illustrated without departing from its spirit or scope. It should be understood by those skilled in the art that various alternatives to the described embodiments may be used in practicing the claims without departing from the spirit and scope as defined in the following claims.

The scope of this disclosure should be determined, not only with reference to the above description, but should be determined with reference to the appended claims, along with the full scope of equivalents to which the claims are entitled. It is anticipated and intended that future developments will occur, and that the disclosed compositions and methods will be incorporated into those future developments.

Furthermore, all terms used in the claims are intended to be given their broadest reasonable construction and their ordinary meaning as understood by those skilled in the art unless an explicit indication to the contrary is made. In particular, use of the singular articles such as “a,” “the,” “said,” etc. should be read to recite one or more of the indicated elements unless a claim recites an explicit limitation to the contrary. It is intended that the following claims define the scope of the disclosure and that the technology within the scope of these claims and their equivalents will be covered. In sum, it should be understood that the disclosure is capable of modification and variation and is limited only by the following claims.

We claim:

1. A plant-based non-dairy fermented base composition comprising:
a. a substrate,
b. a sugar source,
c. a medium,
d. a thickener, and
e. a starter culture.

2. The composition of claim 1, wherein the starter culture comprises live bacteria.

3. The composition of claim 2, wherein the starter culture consists essentially of live bacteria.

4. The composition of claim 1, wherein the medium is a liquid medium.

5. The composition of claim 4, wherein the liquid medium is water.

6. The composition of claim 1, wherein thickener is selected from the group consisting of agar, pectin, arracacha flour, plantain flour, banana flour, banana yogurt, banana puree, locust bean gum “carob,” cassava powder, ground chia seeds, tapioca starch, ground flaxseed, chicory root extract, xantham gum, guar gum, arrow root starch, corn starch, and combinations thereof.

7. The composition of claim 1, wherein the substrate is a plant-based substrate.

8. The composition of claim 7, wherein the plant-based substrate comprises nuts.

9. The composition of claim 8, wherein the nuts of the substrate are selected from the group consisting of almonds, cashews, coconuts, peanuts, hazelnuts, pecans, pistachios, walnuts, macadamia nuts, brazil nuts, pine nuts, chestnuts, and combinations thereof.

10. The composition of claim 1, wherein the substrate, the sugar source, the thickener, and the medium are comprised in a slurry.

11. The composition of claim 10, wherein the slurry further comprises a protein source.

12. The composition of claim 11, wherein the protein source is a pea protein.

13. The composition of claim 10, wherein the slurry further comprises one or more enhancers.

14. The composition of claim 13, wherein the one or more enhancers comprise a flavoring or flavoring agent, a surfactant, an adjuvant, an excipient, a dispersant, an emulsifier, a coloring, an additive, a probiotic, a mineral, a salt, a yeast extract, and combinations thereof.

15. A nutritional product comprising the plant-based non-dairy fermented base composition of claim 1.

16. The nutritional product of claim 15, wherein the nutritional product is a yogurt alternative.

17. The nutritional product of claim 15, wherein the nutritional product is a food, a snack, an elixir, a shot, a shooter, a spoonable product, a spreadable product, a drinkable product, a squeezable product, a smoothie, a shake, a soup, or a beverage.

18. The nutritional product of claim 17, wherein the spoonable product is a yogurt alternative.

19. A method of producing a plant-based non-dairy fermented base composition comprising:
mixing a starter culture and a slurry to form a mixture,
fermenting the mixture to produce an amount of lactic acid,
reducing the pH of the mixture so that the pH ranges from about 3.8 to about 4.6,
cooling the mixture to stop production of the lactic acid, and
producing the plant-based non-dairy fermented base composition.

20. A method of fermenting a plant-based non-dairy fermented base composition comprising:
mixing a starter culture and a slurry to form a mixture,
producing an amount of lactic acid from the mixture,
reducing the pH of the mixture so that the pH ranges from about 3.8 to about 4.6, and
cooling the mixture to stop production of the lactic acid.
